(19) United States
(12) Patent Application Publication
(10) Pub. No.: US 2011/0026222 A1
(43) Pub. Date: Feb. 3, 2011

(54) COMPUTER SYSTEM WITH DETACHABLE FRONT COVER

(76) Inventor: Pei-Hua Sun, Taipei (TW)

Correspondence Address: Dr. BANGER SHIA;Patent Office of Bang Shia, 102 Lindencrest Ct, Sugar Land, TX, 77479-5201, US

(21) Appl. No.: 12/845,082

(22) Filed: Jul. 28, 2010

(30) Foreign Application Priority Data
Aug. 3, 2009 (TW) 098126027

(51) Int. Cl. G06F 1/16

(52) U.S. Cl. 361/679.58; 361/679.02

(57) ABSTRACT

A computer system includes a casing with a front end and a back end, a first opening formed on the front end of the casing, a second opening formed on the back end of the casing and an electronic component with connecting ports. The connecting ports of the peripheral electronic component expose from one of the first opening and the second opening.

### BACKGROUND OF THE INVENTION

1. Field of Invention

The invention relates to a detachable front cover structure and, more particularly, to a detachable front cover structure for disposing an electronic component with the back cover plate.

2. Related Art

A common housing structure of a computer system includes a detachable front cover and a detachable back cover. Slots are reserved behind the detachable front cover to dispose various kinds of apparatus. Generally speaking, the slot includes 5.25-inch size and 3.25-inch size. The 5.25-inch slot is used for disposing an optical disk drive, and the 3.25-inch slot is used for disposing a hard disk drive or a floppy disk drive. The detachable back cover is cooperated with an expansion slot to dispose an interface card such as a graphics card, an audio card, and a network card and expose a connection port of the interface card.

However, as the function of the computer system becomes varied and complicated, some input/output peripheral accessories such as an universal serial bus (USB) connection port, an eSATA connection port, even a fan speed regulator, or a wireless network antenna need to utilize the space at the detachable back cover. A computer is usually put on the ground, and the back of the computer is against a wall or a partition. Consequently, it is rather difficult for users to operate the peripheral accessories at the detachable back cover. The peripheral accessories may occupy the original position of the expansion slot and further causes that users are also unwilling to use and operate the peripheral accessories due to the inconvenient operation.

On the other hand, three to five slots are usually reserved at the detachable front cover of the housing structure. However, since the optical disk drive popularizes, only one optical disk slot at the detachable front cover is used, and other space is wasted in consequence.

### SUMMARY OF THE INVENTION

A computer system according to an embedment of the invention includes a casing, a first opening, a second opening, and an electronic component with a connecting port. The casing includes a front end and a back end. The first opening is formed on the front end of the casing, and the second opening is formed on the back end of the casing. The connecting port of the electronic component exposes from one of the first opening and the second opening.

Moreover, a detachable front cover is detachably disposed in the front end of the casing, and includes an installation portion disposed at a back side thereof. An end of the installation portion includes a fastener, and the installation portion includes at least a through hole thereon. The electronic component further includes a back cover plate and an extension element. The extension element is disposed at the back of the back cover plate, and an operation portion of the extension element is exposed at a front side of the back cover plate. An end of the back cover plate is an inserting portion, and the other end is a bended fastening portion. The inserting portion is inserted in the fastener of the detachable front cover, and the fastening portion is against the edge of the installation portion to make the operation portion of the electronic component exposed from the through hole of the detachable front cover. The fixing part presses at the back cover plate to make the electronic component be fixed firmly.

As a result, by the detachable front cover and the fixing part, the electronic component could be installed at the detachable front cover to allow the user to directly operate and use the extension element from the front side of the computer system. Not only the idle space of the detachable front cover is utilized effectively to save the space occupied by the back cover plate and the expansion slot, it is also convenient for the user to operate the extension element.

These and other features, aspects and advantages of the present invention will become better understood with regard to the following description, appended claims, and accompanying drawings.

### BRIEF DESCRIPTION OF THE DRAWINGS

FIGS. 1A and 1B are schematic diagrams showing a computer system according to an embodiment of the invention;

FIG. 2A to FIG. 2C are schematic diagrams showing a housing structure with a back cover plate and a detachable front cover according to a first embodiment of the invention;

FIG. 3A to FIG. 3B are schematic diagrams showing a housing structure with a back cover plate and a detachable front cover according to a second embodiment of the invention;

FIG. 4A to FIG. 4B are schematic diagrams showing a housing structure with a back cover plate and a detachable front cover according to a third embodiment of the invention; and

FIG. 5A to FIG. 5C are schematic diagrams showing applications of the electronic component according to an embodiment of the invention.

### DETAILED DESCRIPTION OF THE INVENTION

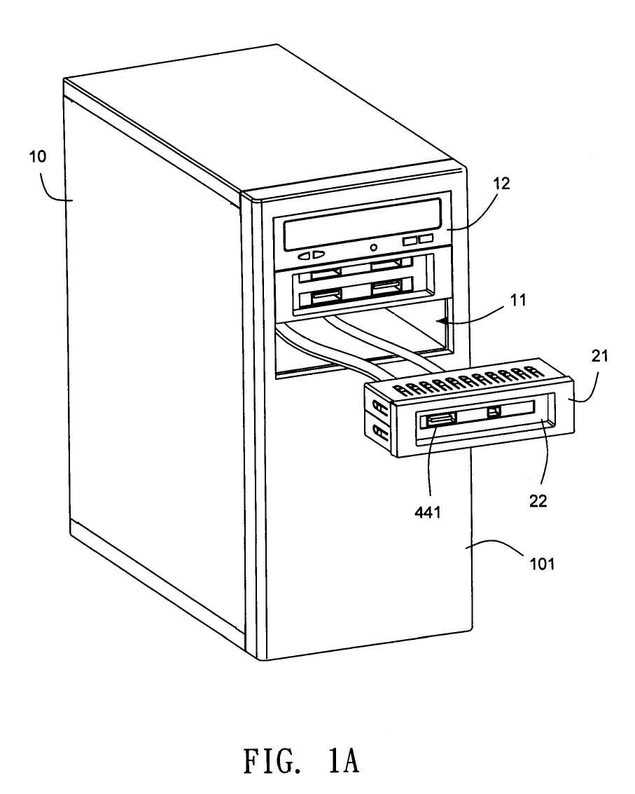

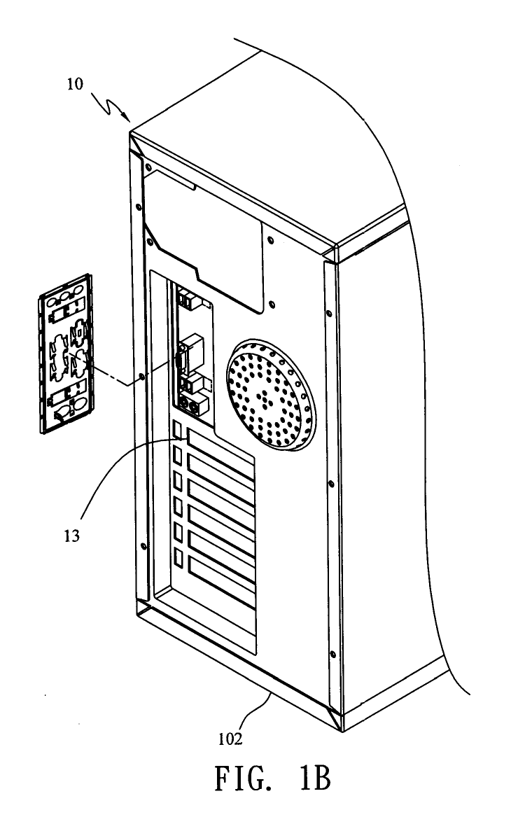

A computer system includes a casing 10 with a front end 101 and a back end 102, please refer to FIGS. 1A and 1B. A first opening 11 is formed on the front end 101 of the casing 10, and a second opening 13 is formed on the back end 102 of the casing 10. The first opening 11 is also named optical disk slot due to the first opening 11 is usually used to disposed with an optical disk drive 12. The electronic component 22 is originally disposed at the back end 102 of a casing 10. Also, the electronic component 22 could be disposed to a detachable front cover 21 in the front end 101 of the casing 10 to facilitate the user's operation.

In an embodiment, the casing 10 includes three first openings 11 (the number is only for explaining but not used for limiting the invention). One first opening 11 is disposed with the optical disk drive 12, and the other two detachable front covers 21 may be provided for disposing the electronic component 22. As a result, not only the idle detachable front cover 21 and the first opening 11 are effectively utilized, the user also easily operates and uses the electronic component 22 directly from the front end 101.

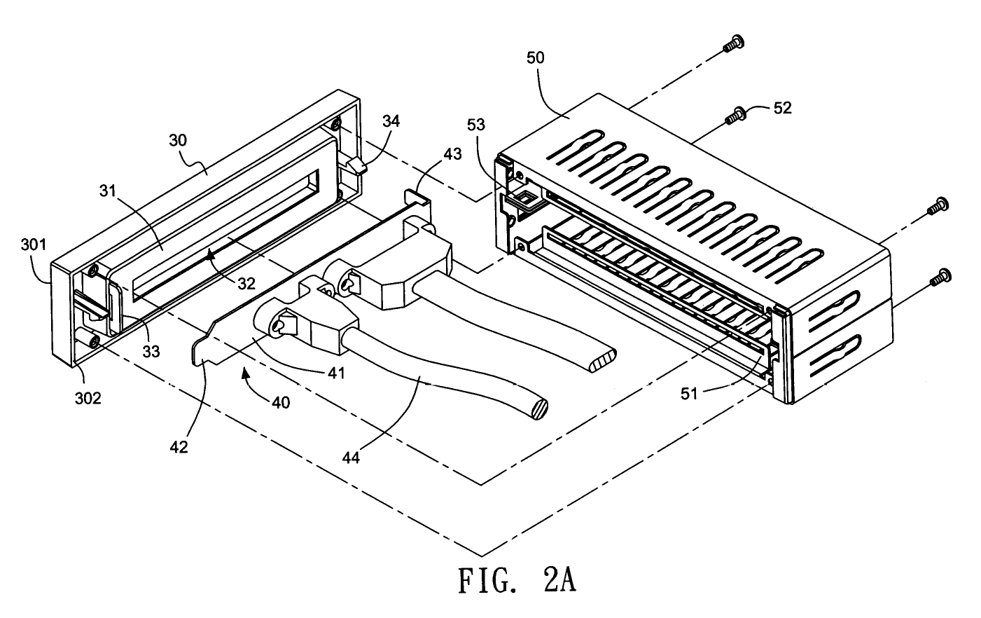

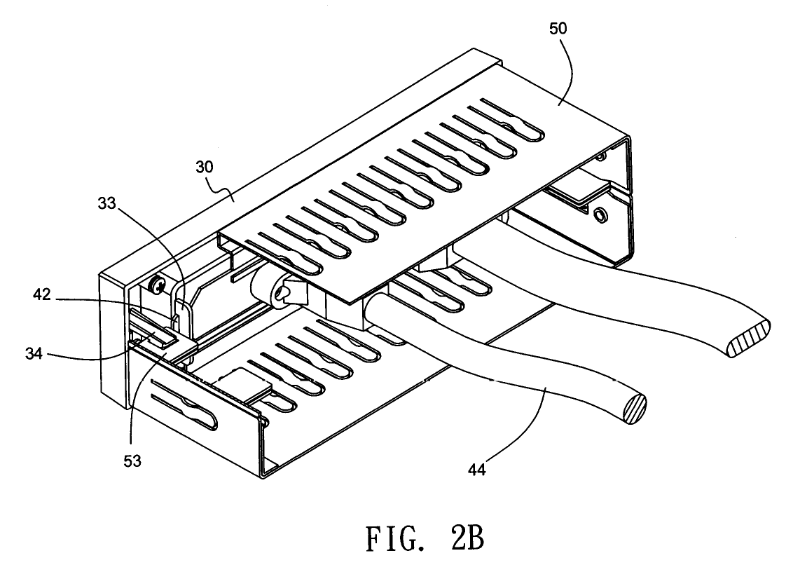

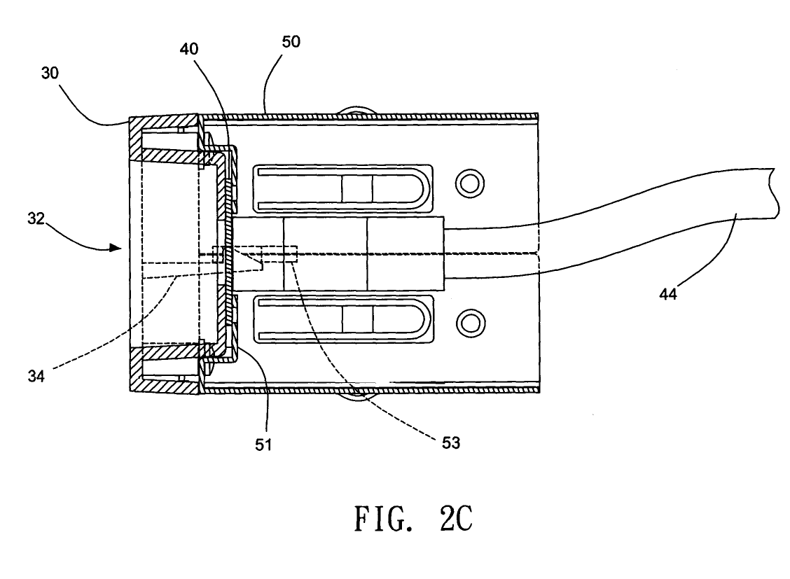

FIG. 2A to FIG. 2C are schematic diagrams showing a housing structure with a back cover plate and a detachable front cover according to a first embodiment of the invention. The detachable front cover structure is used for disposing the electronic component 40 and fixed at the casing 10 (as shown in FIG. 1A).

The detachable front cover structure includes a detachable front cover 30 and a fixing part 50. The detachable front cover 30 is approximately a long plate with a certain thickness, it is detachably disposed in the front end 101 of the casing 10, and it includes a front side 301 and a back side 302 opposite to each other. An installation portion 31 is protrudently disposed at the back side 302. An end of the installation portion 31 includes a fastener 33 (at shown on the left side of the FIG. 2A), and a through hole 32 is formed at the center part of the installation portion 31.

The electronic component 40 includes a back cover plate 41 and an extension element 44. The extension element 44 is disposed at the back of the back cover plate 41, and an operation portion 441 of the extension element 44 is exposed from the front side of the back cover plate 41. As shown in FIG. 2A to FIG. 2C, the extension element 44 may be a transmission line, and thus the operation portion 441 is a corresponding connecting port (as shown in FIG. 1A). An end of the back cover plate 41 is an inserting portion 42 whose size is slightly reduced, the other end of the back cover plate 41 is a bended fastening portion 43, and the type of the back cover plate 41 is a public specification. The size of the fixing part 50 is approximately the same as that of the detachable front cover 30, and it cooperates with the size of the optical disk drive. As a result, the fixing part 50 may be easily disposed in the first opening (optical disk slot) 11 and fixed in the first opening 11 of the casing 10 in an original fixing mode of the casing 10. A common fixing mode includes a screw fixing, a special screwless clip fixing and so on.

As shown in FIG. 2B, the inserting portion 42 at the end of the back cover plate 41 of the electronic component 40 is inserted into the fastener 33 of the installation portion 31 of the detachable front cover 30. The size of the fastener 33 is designed to cooperate with the inserting portion 42. As a result, when the inserting portion 42 is inserted, and the fastening portion 43 is cooperatively against an edge of the other end of the installation portion 31, the degree of freedom of the inserting portion 42 is restricted. Thus, the back cover plate 41 is flat against the installation portion 31 to make the operation portion 441 of the extension element 44 exposed from the through hole 32. Afterwards, the fixing part 50 is assembled at the back side 302 of the detachable front cover 30. An inwardly extended pressing portion 51 at the front end of the fixing part 50 presses the edge of the back cover plate 41 of the electronic component 40, and hooks 34 extended at two sides of the detachable front cover 30 are hooked in the clips 53 of the fixing part 50, and thus the fixing part 50 is initially located and positioned. Then, screws 52 are utilized to further fix the fixing part 50.

Consequently, the inserting portion 42 of the back cover plate 41 of the electronic component 40 is restrained by the fastener 33, and cooperating with the press made by the pressing portion 51 of the fixing part 50, the electronic component 40 is firmly fixed.

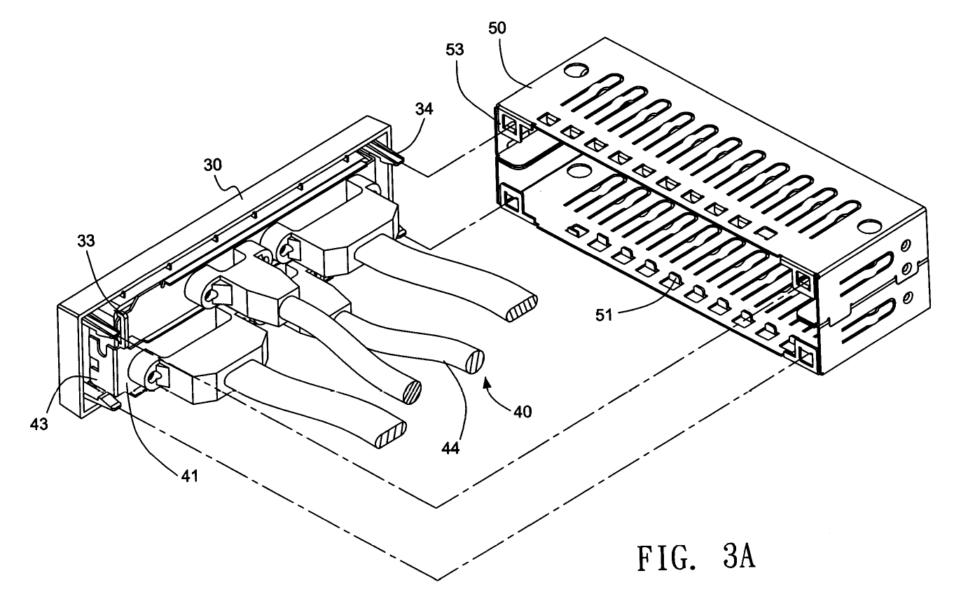

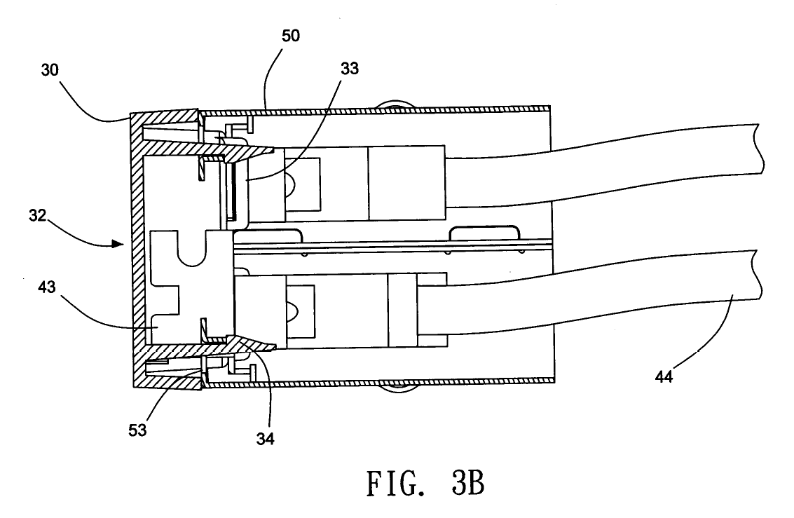

FIG. 3A to FIG. 3B are schematic diagrams showing a housing structure with a back cover plate and a detachable front cover according to a second embodiment of the invention.

Considering that the detachable front cover 30 with the 5.25-inch public specification is about twice wider than the back cover plate 41, two through holes 32 may be designed at one installation portion 31 of the detachable front cover 30 to fix the two electronic components 40. To prevent the back cover plates 41 of the two electronic components 40 from interfering with each other, the back cover plates 41 are disposed in two directions reversed to each other, respectively. Furthermore, since the screws 52 are needed to lock in the first embodiment, a hand tool (such as a screwdriver) is also needed to fix the fixing part 50. As a result, in the second embodiment of the invention, a plurality of hooks 34 are designed at the detachable front cover 30 (as shown in FIG. 3A, the number of the hooks is four, and the hooks are located at four corners of the detachable front cover 30) to provide enough combination strength, the screws 52 are saved. Thus the installation is more convenient. Moreover, the shape of the pressing portion 51 of the fixing part 50 also may be changed from a long sheet in the first embodiment to a plurality of small sheets in this embodiment.

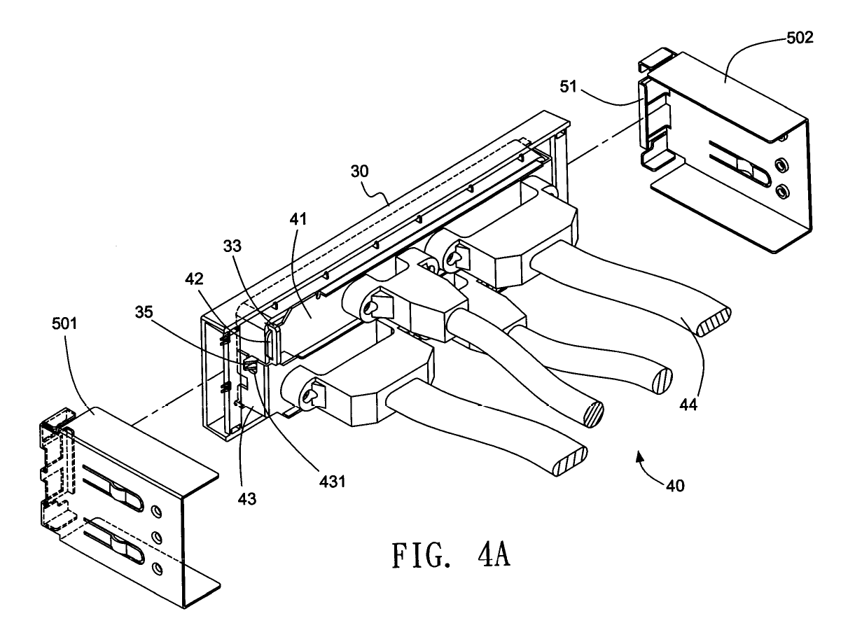

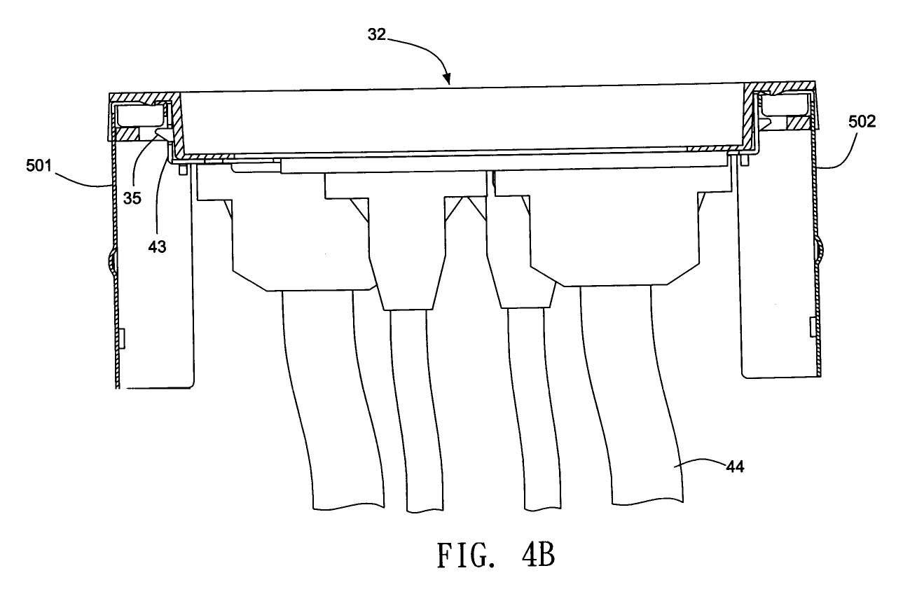

FIG. 4A to FIG. 4B are schematic diagrams showing a housing structure with a back cover plate and a detachable front cover according to a third embodiment of the invention.

In the second embodiment, since the back cover plate 41 is restrained only by the fastener 33, the fixing part 50 is needed to press at the edge of the back cover plate 41. Consequently, the volume of the fixing part 50 is rather large. To further reduce the cost of the fixing part 50 and facilitate the installation, positioning portions 35 are protrudently disposed at the two side of the installation portion 31 of the detachable front cover 30. When the inserting portion 42 at the rear end of the back cover plate 41 of the electronic component 40 passes through the fastener 33, not only the fastening portion 43 of the back cover plate 41 is against the edge of the installation portion 31, the positioning portion 35 also passes through the existing fastening hole 431 to restrain the degree of freedom of motion of the back cover plate 41. Thus, the back cover plate 41 only may move leftward or rightward. The fixing part 50 includes two-piece pressing units 501 and 502. As a result, with the cooperation of the pressing units 501 and 502 installed from the left and the right sides, the pressing portions 51 press at the fastening portions 43 of the back cover plate 41, the back cover plate 41 is fixed. Consequently, not only the cost of the fixing part 50 is reduced, the installation is also more convenient.

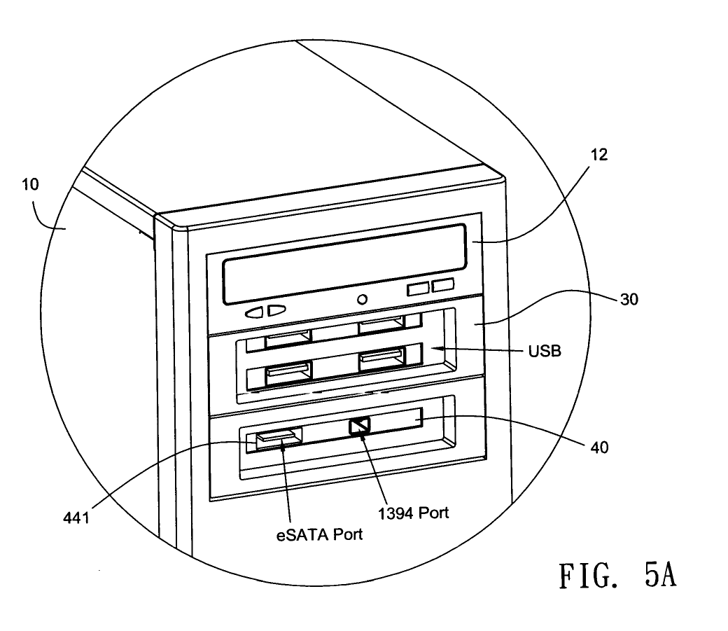

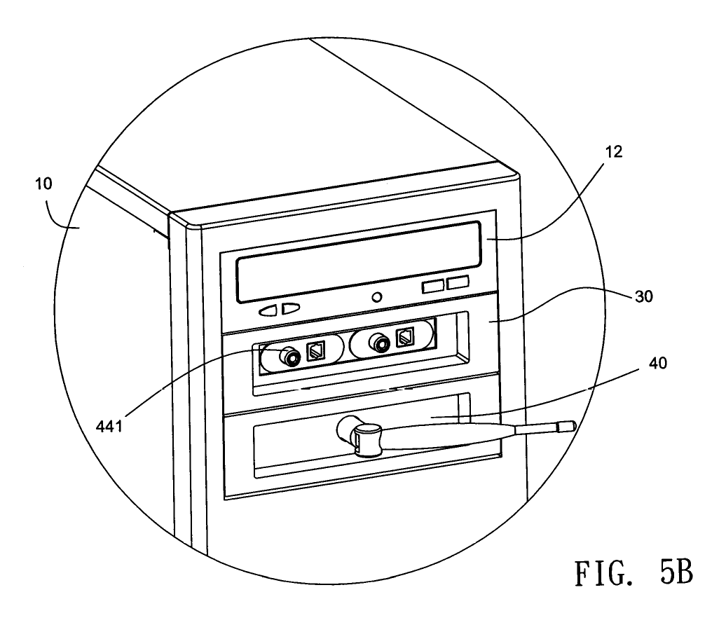

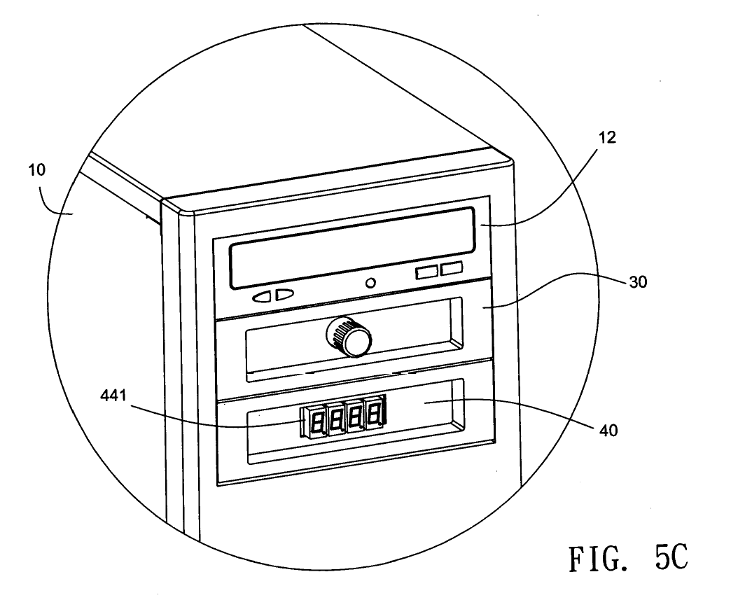

In practical usage, since the extension element 44 may be a transmission line, the operation portion 441 is a corresponding connecting port. As shown in FIG. 5A, the connecting port may be a universal serial bus (USB), an external SATA port, or a 1394 connecting port, audio-visual input/output ports. Also, the operation portion 441 may be a built-in wireless network antenna (as shown in FIG. 5B), a fan regulating control knob or a digit code display for a debug card (as shown in FIG. 5C). The operation portion 441 may be moved to the detachable front cover of the housing structure front panel according to the invention to facilitate the operation of the user.

According to the computer system of the invention, the electronic component originally disposed in the expansion slot is moved to the detachable front cover. Thus, not only the expansion slot is available to dispose the interface card which indeed needs the expansion slot, the detachable front cover and the optical disk slot also may be utilized effectively. Furthermore, the electronic component is moved to the front panel to facilitate the user's operation, such as connecting various kinds of USB flash disks, an external SATA hard disk, a 1394 hard disk, or inputting or outputting audio-visual data, adjusting the angle of the antenna to obtain the best transmission angle, adjusting the fan control knob from the front side to control the rotating speed of the fan, or displaying the digit code of the debug card to directly read an error post code.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A computer system comprising:
a casing having a front end and a back end;
a first opening formed on the front end of the casing;
a second opening formed on the back end of the casing; and
an electronic component with a connecting port disposed at one of the front end and the back end of the casing to make the connecting port of the electronic component expose from one of the first opening and the second opening.

2. The computer system according to claim 1, wherein the first opening is covered by a detachable front cover with a through hole.

3. The computer system according to claim 2, wherein the connecting port of the electronic component is exposed via the through hole of the detachable front cover.

4. The computer system according to claim 3, wherein the electronic component comprises a back cover plate to detachably connect to the detachable front cover.

5. The computer system according to claim 4, further comprises a fixing part to fix the electronic component by the back cover plate.

6. The computer system according to claim 5, wherein the back cover plate comprises a fastening portion to fix the fixing part.

7. The computer system according to claim 6, wherein the fixing part comprises two pressing units fixed respectively at two sides of the front cover plate to press at the fastening portions of the back cover plate.

8. The computer system according to claim 4, wherein the detachable front cover comprises an installation portion and the back cover plate comprises an inserting portion to insert in the installation portion.

9. The computer system according to claim 7, wherein the installation portion of the detachable front cover includes a positioning portion to be fastened to a fastening hole of the fastening portion of the back cover plate.

10. The computer system according to claim 3, wherein the electronic component has an operation portion, and the operation portion is exposed from the through hole of the detachable front cover.

11. The computer system according to claim 10, wherein the operation portion of the electronic component is one or a combination of a connection port, an antenna, a control knob, and a digital code display.

12. The computer system according to claim 1, wherein the first opening is adapted to expose part of an optical disk device.
